(19) United States
(12) Patent Application Publication
(10) Pub. No.: US 2003/0236698 A1
(43) Pub. Date: Dec. 25, 2003

(54) Method and system for collecting, storing, managing and distributing references using networked computer devices

(75) Inventors: Haruyoshi Miyagi, Lehi, UT (US); Cyril Chih-Yang Huang, Orem, UT (US)

Correspondence Address: Lloyd W. Sadler, Parsons Behle & Latimer, Suite 1800, 201 South Main Street, Salt Lake City, UT, 84111, US

(73) Assignee: PraiseDepot, LLC, Lehi, UT

(21) Appl. No.: 10/176,859

(22) Filed: Jun. 20, 2002

(51) Int. Cl. G06F 17/60

(52) U.S. Cl. 705/11

(57) ABSTRACT

A method and system for collecting, distributing and managing feedback and/or references from one or more persons for users is described. This invention provides a marketing tool for persons who use or would like to use personal references in their personal marketing or job-hunting processes. Making use of an on-line networked system, references are provided in a consistent user and reference friendly manner, while providing the potential customer or employer with easy access to reference information.

### BACKGROUND OF INVENTION

1. Field of the Invention

This invention relates to computer information systems and methods for using such computer information systems. More specifically, this invention relates to computer information systems and methods that provide a controlled process for collecting, managing and providing access to customer/client comments and references.

2. Description of Related Art

A variety of computer based information systems are well known in the art. Generally, these prior systems do not facilitate management of the information by a third party, do not facilitate references concerning specific individuals, do not efficiently facilitate the accumulation and accessibility of credentials on-line, and do not maintain the references and feedback information in a long term consistent form.

Although the following documents may not necessarily be “prior art”, the reader is referred to the following U.S. patent documents for general background material. Each of these patents is hereby incorporated by reference in its entirety for the material contained therein.

U.S. Pat. No. 5,262,941 describes an expert floor plan credit recommendation method and system, comprising a database and stored program for arriving at a credit recommendation by processing data on a computer by means of a decision matrix tree that emulates the thought processes of credit experts.

U.S. Pat. No. 5,537,314 describes a credit accumulation and accessing system for a plurality of sponsoring companies and participants having at each sponsoring company location, a common bus, which communicates with participant data input, performance data input, computer processing, memory, an award output device, and an input/output device.

U.S. Pat. No. 5,551,880 describes a system for predicting potential of success of an individual for a particular job or task.

U.S. Pat. No. 5,812,959 describes a system and method for determining which of a plurality of vehicles is able to respond most quickly to an event.

U.S. Pat. No. 5,890,152 describes a personal feedback browser and personal profile database that is provided for obtaining media files from the Internet.

U.S. Pat. No. 5,999,929 describes a link referral system includes a classification arrangement for classifying Web pages that the system retrieves over the World Wide Web.

U.S. Pat. No. 6,029,141 describes an Internet-based referral system that enables individuals and other business entities to market products, in return for a commission, that are sold from a merchant's Web site.

U.S. Pat. No. 6,041,311 describes a method for recommending items to users using automated collaborative filtering stores profiles of users relating ratings to items in memory.

U.S. Pat. No. 6,157,808 describes a computer system and method for a computer-based data integration and management processing system and method to support an efficient management of employee development, training and performance improvement in a performance-competence based organization.

U.S. Pat. No. 6,195,657 describes a system for determining recommendations, which are likely to be relevant to a user's current tasks.

U.S. Pat. No. 6,233,517 describes a system and method for determining which of a plurality of vehicles is able to respond most quickly to an event.

U.S. Pat. No. 6,236,980 describes a computer apparatus used to automatically generate displays or reports containing investment security or element recommendations along with an optional summarization of the reasons for the recommendation.

U.S. Pat. No. 6,356,879 describes a method for product-peer filtering that derives product characterizations for products offered at an e-commerce site based on the test descriptions of the products provided at the site.

U.S. Pat. No. 6,360,254 describes a Web site system in which different private records or other resources are personal to different users, in which a method is provided for allowing users to securely access a private resource without the need to enter a username, password, or authentication information and without the need to download special authentication software or data to the user's computer.

U.S. Pat. No. 6,366,950 describes a communications network that includes several computers connected to a communications medium.

U.S. Pat. No. 6,370,513 describes an automated recommendation system that keeps track of the needs and preferences of the user through a user preference vector.

### SUMMARY OF INVENTION

It is desirable to provide a method and system for managing the collection and distribution of personal feedback and/or references. In particular, it is desirable to provide an on-line computerized process for collecting and accessing recommend letters, personal references, resumes, customer feedback, surveys, and testimonials.

Accordingly, it is an object of this invention to provide a method and system for the management of feedback information from customers, employers, teachers and the like.

Another object of this invention is to provide a method and system for management of feedback information that provides an on-line capability for collecting information regarding personal and business capabilities and performance.

A further object of this invention is to provide a method and system for management of feedback information that permits a user to access references and information over a computer network.

A still further object of this invention is to provide a method and system for management of feedback information that facilitates the accumulation of reference information for the user's use in promoting a person or business.

It is another object of this invention to provide a method and system for management of feedback information that eliminates the need for maintaining a binder full of recommend letters by documenting and advertising professional references on-line.

It is a further object of this invention to provide a method and system for management of feedback information that includes user specific on-line addresses as access control to the feedback information.

It is a still further object of this invention to provide a method and system for management of feedback information that improves delivery of reference information.

Another object of this invention is to provide a method and system for management of feedback information that facilitates advertising of good personal or business practices.

A further object of this invention is to provide a method and system for management of feedback information that permits control of access to collected information by the referenced user.

A still further object of this invention is to provide a method and system for management of feedback information that simplifies the process of preparing reference or recommend letters.

Moreover, another object of this invention is to provide a method and system for management of feedback information that permits the person providing information to determine how much information is disclosed to the public.

It is a object of this invention to provide a method and system for management of feedback information that provides the capability for potential customers/employers to view credible references privately on-line.

It is another object of this invention to provide a method and system for management of feedback information that provides the verification of references.

It is a still further object of this invention to provide a method and system for management of feedback information that is appropriate for use by professionals, companies, job seekers, and the like, to collect and distribute reference information to interested parties.

Additional objects, advantages, and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described present preferred embodiments of this invention, simply by way of illustration of some of the modes best suited to carry out this invention. As it will be realized, this invention is capable of other different embodiments, and it several details, and specific steps and system components are capable of modification in various aspects without departing from the invention. Moreover, some embodiments of the invention may provide some or all of the objects of this invention. Therefore, this list of desired objects may not necessarily be found in each embodiment and should not be considered limiting. Similarly, the drawings and descriptions should be regarded as illustrative in nature and not as restrictive.

To achieve the foregoing and other objectives, and in accordance with the purposes of the present invention, the present embodiment of this invention incorporates the use of standard computer components, typically operating in concert with a computer network, executing a software program of the process of this invention.

### BRIEF DESCRIPTION OF DRAWINGS

The accompanying drawings incorporated in and forming a part of the specification, illustrate a preferred embodiment of the present invention. Some, although not all, alternative embodiments are described in the following description.

In the drawings:

FIG. 1 is a flow chart of the steps of the present preferred method of this invention.

FIG. 2 is a system block diagram of the computer system typically used in concert with this invention.

FIG. 3 is an information flow diagram of the information management process of the present preferred embodiment of this invention.

FIG. 4 is a detailed flow chart of the data collection process of the present preferred embodiment of this invention.

FIG. 5 is a detailed flow chart of the data accessing process of the present preferred embodiment of this invention.

Reference will now be made in detail to the present preferred embodiment of the invention, an example of which is illustrated in the accompanying drawings.

### DETAILED DESCRIPTION

This invention is a method and system for collecting, managing and distributing personal references using networked computers. In many industries, trades and professions it is expected that references, as to the quality of one's work or credentials, be provided to potential future customers and/or employers. However, the collection and management of such references has traditionally required that the person or entity requesting the references, referred to in the document as the “customer” or “potential customer” inform the person of interest, that is the person for whom references are to be provided, referred to hereafter as the “user”. If the user does not have appropriate references readily available, the user must contact potential referring persons (“praisers”) and request a helpful reference. Inevitably, the provided references describe different attributes and qualities of the user and they are typically not well adapted to statistical techniques. For example, it might be helpful to quantify a response to a particular inquiry and then to be able to provide a potential customer with both specific quantified responses and statistics such as mean and standard deviation of the group of responses. Also, from a user point of view, since some customers request that the reference be sent directly by the praiser to the customer, it is not always possible to control access to a particular reference. A user would like to have the opportunity to review references, also called in this document a “praise” or “praise note”, before a customer has access to them. Also, for many industries, trades and professions, it would be very beneficial if access to references could be provided to the general or interested public, who could access the references without necessarily specifically requesting the references in person from the user. For example, a general contractor might wish to advertise, perhaps in a printed publication, an Internet web-site where potential customers could access and read prior customers comments and references. Another example is that of an accountant who would like to provide an indication of a web-site where references can be found on his business card.

This invention addresses these problems and needs by allowing registered users to collect feedback, ensure that the feedback is positive, from satisfied praisers (such as past customers, clients and employers) and provide these praises (reference feedback) to potential future customers, clients, employers and the like. In many ways this invention provides an advertising function, in that it provides the capability for the user to present the praises that are positive and helpful to his or her marketing efforts. It also provides a method for easily and consistently gathering information from customers and clients. This gathered information can be very valuable to the user in efforts to improve quality of services rendered.

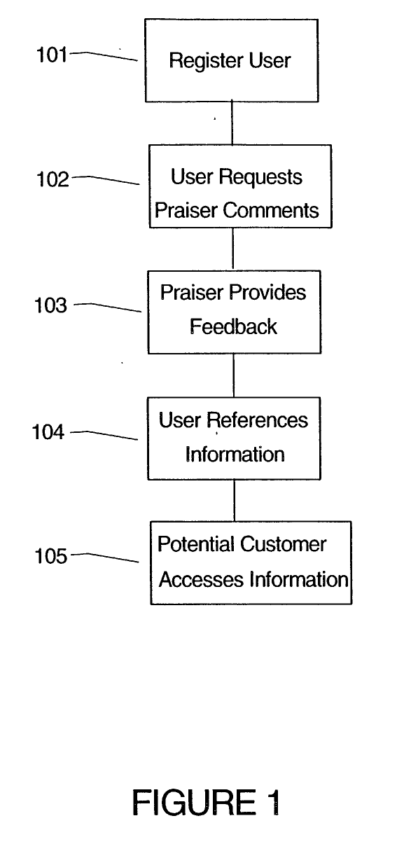

FIG. 1 shows a flow chart of the steps of the present preferred method of this invention. The future user first registers 101 with the system of this invention. Typically, user registration includes providing at least some or all of the following information: user name, payment (presently credit card) information; e-mail address, password, telephone number, fax number, residence address, industry, years of experience, business name, business telephone number, business address and business web site address. Once registered, a user can request 102 feedback from one or more praisers. The user can select only satisfied praisers and can request only positive feedback, as might be appropriate for advertising purposes, and/or can solicit any feedback from any or all past customers, as would be appropriate for quality control purposes. Typically, this request 102 feedback step is accomplished by the registered user accessing the system of this invention, generally using a networked computer system. Once the user is logged in to the system, the user submits a request for praiser comments/ratings. This request includes the information necessary for the system of this invention to contact the potential praiser, including: name, relationship to user, business name, e-mail address, telephone number, fax number and address. An e-mail message requesting this information and providing the necessary access information is then automatically sent to the potential praiser. The praiser, after receipt of the e-mailed request 102, accesses the computer system of this invention and provides 103 the desired and requested feedback. The present mode of this invention facilitates the collection of the feedback by simplifying the praisers data collection process and minimizing the time required to submit the desired reference information. In the present embodiment, this is accomplished through the use of an embedded hyper link in the request e-mail message. The information collection itself is presently accomplished in a “button click” format, with several options (ranging from poor, average, good, very good, to excellent) for each of several criteria for the person for whom a reference is intended. In the present embodiment the criteria are: service, quality, professionalism, timeliness, and overall. A comments box is provided for free format comments. Naturally, it is expected that in other embodiments of this invention different rankings (for example a 1-10 scale) and different criteria (for example price, efficiency, friendliness and professional skill) could be added without departing from the concept of this invention. The praiser may also be provided the opportunity of deciding how much of their own personal information is available to someone viewing the reference information, or praise note. A verification step is also presently provided to permit the praiser to review his or her praise note before submitting it to the database of praise notes. After the praise note reference has been submitted as part of the praiser providing 103 feedback, the user can access 104 or reference the information provided. The user is provided, as part of this access 104, with the capability of deciding whether to have the information viewable or accessible by potential future customers. In the present preferred embodiment, the user does not have the ability to edit any specific reference or praise note, as this could seriously undermine the credibility of the system. Customers and potential customers can log into the system of this invention to gain access to a list of comments/ratings (feedback, or praise notes) provided by past clients, customers, and/or employers of the registered user. In various embodiments of this invention, the customer/potential customer can access specific praise notes as well as the statistics compiled from the entire set of praise notes. Both fixed (quantitative information) and soft (free form text) information is typically available to the customer/potential customer for each registered user. In envisioned other embodiments, a comparison between the registered user and other registered users in the same field can also be provided. Some embodiments of this invention will also permit the registered user to “post” or store his or her vitae or resume on line for access and printing by a customer/potential customer/future employer essentially with a simple “mouse click” access.

In alternative embodiments, the information may be very limited, for example in some embodiments the only information provided may be an FBI or other criminal agency clearance verification. In such embodiment, effectively the only customer providing a reference would be the appropriate government agency. In other embodiments, this invention could be used as an on-line (local area network) employee review system, where the “customer” role is provided by the employer and “future customer” may be other company management. This embodiment would be directed to providing useful nearly real-time feedback to the employee and would permit management to have nearly continuous information about an employee's skills and work habits.

A wide variety of other uses and embodiments of this invention are planned and under consideration.

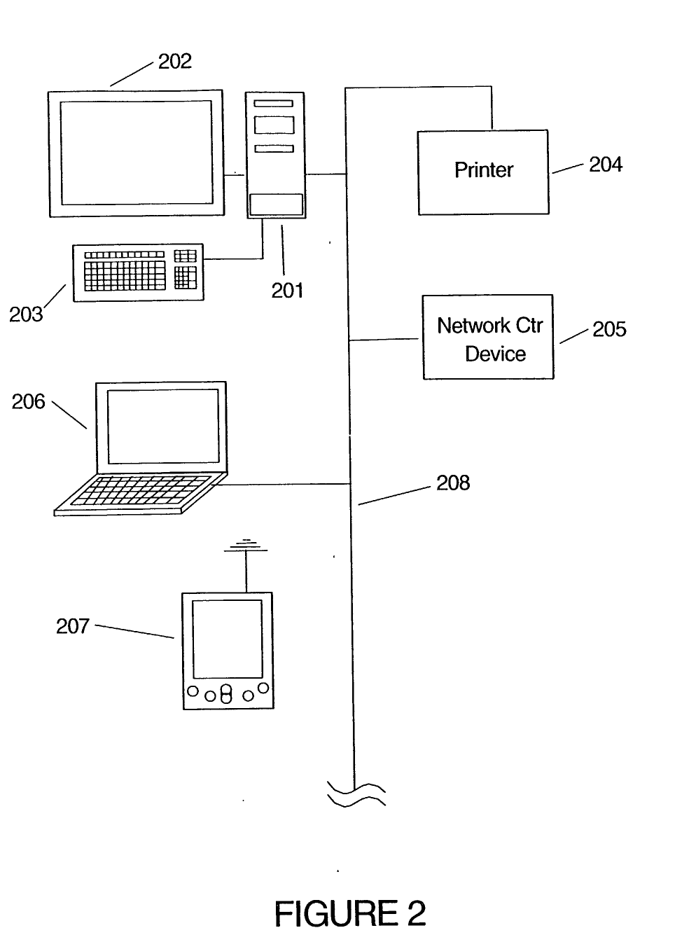

FIG. 2 shows a system block diagram of the computer system typically used in concert with this invention. This invention operates with, or as a part of, a networked computer system. The user, customer and praiser all interact with the system and method of the invention through computer access. Typically, in the present embodiment, the user uses his or her computer system 201 to log into a remote networked computer system 205. The remote networked computer system 205 has a processor for executing the process of this invention and for interacting with the users, customers and praisers, a memory device for storing program information, web-page information and praise notes. In some embodiments of this invention, the remote networked computer 205, may actually be more than one computer, and may be a large number of Internet servers accessible over the Internet. The preferred network 208 is the Internet, although as previously described, alternative networks, such as LANs and WANs could be substituted in some embodiments without departing from the concept of this invention. A printer 204 is typically provided to permit the user and/or system administrator to have hard copies of praise notes and/or reports. A wide variety of computing devices may be used, by the user, customer and praiser to access and interact with the system and method of this invention. Such computing devices include, but are not necessarily limited to desk top computers 201 having an input device 203 and a display; portable, lap top or notebook computers 206; and personal data assistants 207, which may include PDA compatible telephones and the like.

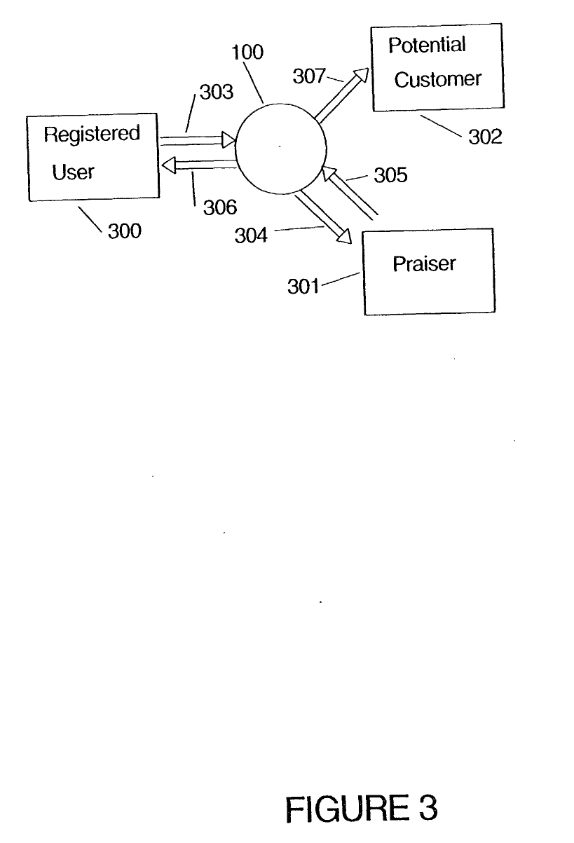

FIG. 3 shows an information flow diagram of the information management process of the present preferred embodiment of this invention. The registered user 300 requests 303 a praise note through the system/method of this invention 100. The invention 100 generates an e-mail request 304 to a praiser 301. The praiser 301 responds with a feedback praise note 305, which is received and held in memory in the system of the invention 100. The user accesses and receives 306 the received praise note, as does 307 a potential customer. If the potential praiser 301 declines to respond with a praise note, an e-mail message is automatically generated by the system 100 and sent 306 to the user 300.

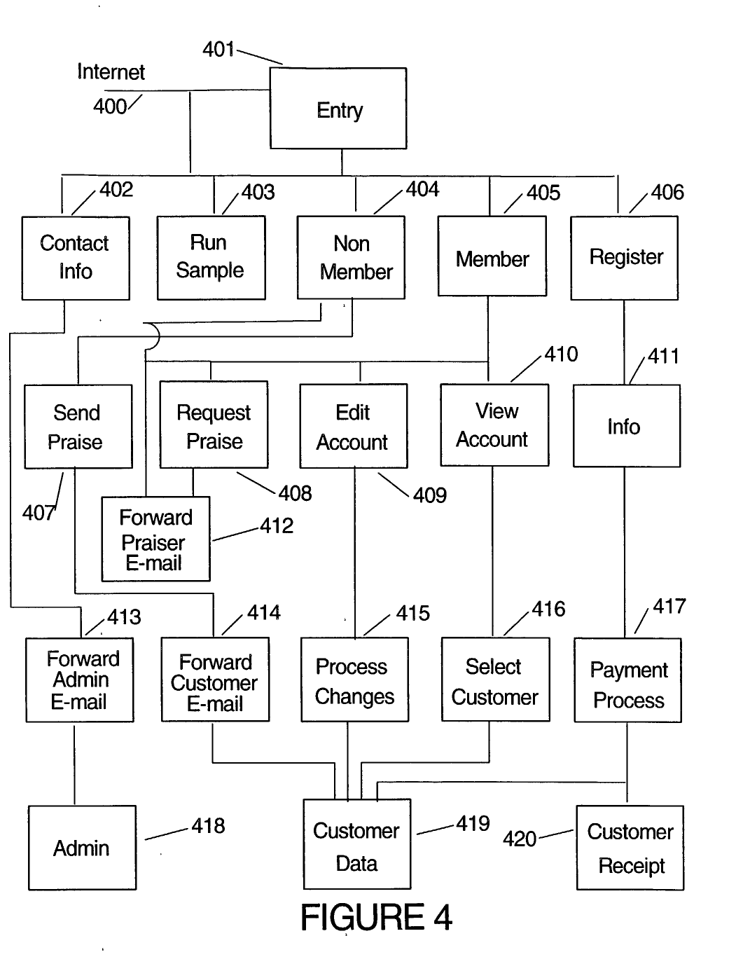

FIG. 4 shows a detailed flow chart of the data collection process of the present preferred embodiment of this invention. Since the data collection in the present embodiment of the invention is accomplished through Internet access to a web-site, this diagram also shows the present relationships (or mapping) between various web-site pages. The Internet 400 connection permits a user/customer/praiser to either go through the entry (or home page) 401 or to go directly to the page of particular interest. The present entry page 401 includes links to an “about us” page, providing information about the company providing this invention; a career page, providing job information with the company; a FAQ page, providing answers to frequently asked questions; a legal page, providing disclosure of rights, obligations, and warranties; and a privacy page, providing a description of the privacy capabilities of this system and method. A registration page 406 is provided as a gateway to the user registration process. If a new user wishes to register, they proceed to the Info page 411 where the above-described information is collected. The payment process page 417 is then entered, where in the present embodiment, the user is prompted to provide credit card information. All of this information is stored in the customer database and is reviewable in the customer data page 419. A member page 405 is the gateway for registered members. Through this member page 405 registered users may view their account on a view account page 410, edit their account information in the edit account page 409 and request a praise not in the request praise page 408. If the user wishes to view his or her account, he or she progresses to the select customer page 416 and retrieves data from the customer data page 419. If the user wishes to edit his or her account, he or she progresses to the process changes page 415, retrieves and writes data from and to the customer data page 419. If the user wishes to request a praise note, the request praise page is entered, where the user provided the praiser information. Once this praiser information and praise note request is received an e-mail message is forwarded to the customer, typically through the non-member page 404, or alternatively, this e-mail message can be sent directly to the customer or through the member page 405. If a praiser or non-member accesses the system to provide a praise note, he or she proceeds through the non-member page 404, to the send praise page 407. The send praise page 407 is forwarded to the customer e-mail page 414 and is stored in the customer data page 419. A run sample page 403 is provided so that potential users can gain some familiarity with the system. A contact info page 402 is provided to permit feedback or to submit questions to the system administrator through an administrative forward e-mail 413 to the administration 418.

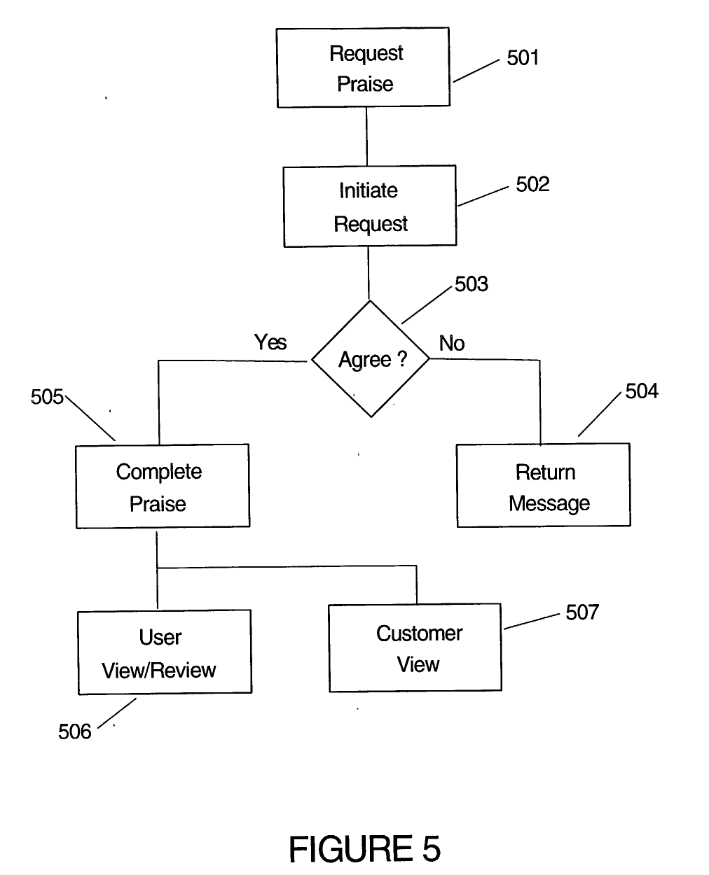

FIG. 5 shows a detailed flow chart of the data accessing process of the present preferred embodiment of this invention. This diagram shows the flow of a typical praise request and response process. The user requests 501 a praise note by submitting such a request to the networked computer system managing the process of this invention. This process then initiates 502 a request and forwards the request to the potential praiser via e-mail. The potential praiser has the choice of accepting or declining the request. If 503 the potential praiser declines the request, a return message 504 is sent to the user. If the potential praiser accepts the request, he or she completes 505 the praise note, after which, the user may view and review 506 the praise note provided by the praiser and a potential customer may view 507 the praise note, along with in some embodiments, a variety of statistics.

It is to be understood that the above described and referenced embodiments and examples are merely illustrative of numerous and varied other embodiments and applications which may constitute applications of the principles of this invention. These example embodiments are not intended to be exhaustive or to limit the invention to the precise form, connection or choice of components, or materials disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is the intent of the inventor that they be deemed to be within the scope of this invention, as determined by the appended claims when they are interpreted in accordance with the breadth to which they are fairly legally and equitably entitled.

1. A method for managing the collection and distribution of personal reference information, comprising:
(A) registering a user;
(B) requesting a praiser comment;
(C) receiving feedback from said praiser; and
(D) accessing said received feedback.

2. A method for managing the collection and distribution of personal reference information, as recited in claim 1, further comprising accessing said feedback by said user.

3. A method for managing the collection and distribution of personal reference information, as recited in claim 1, further comprising determining whether said feedback shall be made available to a customer.

4. A method for managing the collection and distribution of personal reference information, as recited in claim 1, wherein said requesting a praiser comment is made using e-mail.

5. A method for managing the collection and distribution of personal reference information, as recited in claim 1, wherein said receiving feedback from said praiser further comprises receiving an indication that said praiser is declining to provide a personal reference.

6. A method for managing the collection and distribution of personal reference information, as recited in claim 1, wherein said receiving feedback from said praiser further comprises receiving a personal reference.

7. A method for managing the collection and distribution of personal reference information, as recited in claim 1, wherein said accessing said received feedback, further comprises receiving to a user said received feedback.

8. A method for managing the collection and distribution of personal reference information, as recited in claim 1, wherein said accessing said received feedback, further comprises receiving to a potential customer said received feedback.

9. A method for communicating personal reference information, comprising:
(A) receiving a request for personal reference information;
(B) transmitting said request for personal reference information;
(C) receiving a response to said transmitted request for personal reference information; and
(D) providing said response to a user.

10. A method for communicating personal reference information, as recited in claim 9, wherein said receiving a request for personal reference information comes from a user requesting information on his on personal qualities.

11. A method for communicating personal reference information, as recited in claim 9, wherein transmitting is accomplished via e-mail.

12. A system for managing collection of and access to personal reference information, comprising
(A) a user computer system, having a network connection;
(B) a customer computer system having a network connection;
(C) a praiser computer system having a network connection; and
(D) a network computer in communication with said user computer system, said customer computer system and said praiser computer system over a computer network, and wherein said network computer system further comprises a database storage device containing one or more praise notes for access by said user computer system and said customer computer system.
